(19) United States
(12) Patent Application Publication
(10) Pub. No.: US 2013/0232074 A1
(43) Pub. Date: Sep. 5, 2013

(54) System and Method for Providing Alert Messages with Modified Message Elements

(71) Applicants: Mark Carlson, Half Moon Bay, CA (US); Surendra Keshan, Cupertino, CA (US)

(72) Inventors: Mark Carlson, Half Moon Bay, CA (US); Surendra Keshan, Cupertino, CA (US)

(21) Appl. No.: 13/786,177

(22) Filed: Mar. 5, 2013

Related U.S. Application Data
(60) Provisional application No. 61/606,726, filed on Mar. 5, 2012.

(51) Int. Cl. G06Q 20/42

(52) U.S. Cl. CPC G06Q 20/42
USPC 705/44; 705/39

(57) ABSTRACT

Embodiments of the invention provide for alert messages with modified transaction alert message elements and non-modified transaction alert message elements. The modified transaction alert message elements are designed to call the user's attention to them. They may relate to transaction details that are somewhat abnormal, and therefore potentially fraudulent.

### CROSS-REFERENCES TO RELATED APPLICATIONS

This application is a non-provisional application of and claims the benefit of priority of U.S. Provisional Application No. 61/606,726 filed on Mar. 5, 2012, which is herein incorporated by reference in its entirety for all purposes.

### BACKGROUND

Embodiments of the invention are directed to systems and methods for fraud prevention related to financial transactions.

Alert messages for financial transactions provide a fast and convenient way of informing consumers when an action occurs on their financial account. For example, alert messages may be provided when the account balance becomes too low, or an automatic deposit is made in to the account, or a scheduled payment is made from the account. An alert message can also be used to prevent fraud, since an alert message can alert a consumer about a transaction that he did not conduct. A typical transaction alert message may include transaction details, such as, a consumer name, account information, a transaction amount, a merchant name, a merchant location, a date and time of the transaction, etc. Alert messages are typically in the form of an email or a text message.

One problem with alert messages is that consumers may receive too many alert messages, and an abundance of alert messages may obscure alert messages that should be notifying a consumer about potential fraud. For example, it is not uncommon for a person to receive over 5, 10 or 20 alert messages on their mobile phone per day, especially when multiple people (e.g., family members) conduct transactions on the same account. Further, such transaction alert messages generally have the same format so they tend to look the same to the consumer. It is possible that the consumer may no longer view the alert as being special and may only view the alert as being a routine communication. If one of twenty alert messages received by a consumer's mobile phone during the day is actually the result of a fraudulent transaction, the consumer may miss the significance of the alert message.

Embodiments of the invention address this and other problems, individually and collectively.

### BRIEF SUMMARY

Embodiments of the invention provide an additional level of fraud prevention by clearly identifying any abnormal transaction detail relating to a transaction in the transaction alert message. An abnormal detail may include a variation from the norm relative to similar details for past transactions. Using embodiments of the invention, the transaction detail that may be abnormal may be clearly identified in a transaction alert message by highlighting or otherwise modifying the transaction detail so that it stands out from the other transaction details.

One embodiment of the invention relates to a method of receiving transaction details for a transaction; analyzing, by a server computer, the transaction details to determine if a transaction detail is abnormal; determining, by the server computer, that the transaction detail is abnormal; generating, by the server computer, an alert message, wherein the alert message comprises a plurality of alert message elements, and a modified alert message element, wherein the modified alert message element is generated in response to determining that the transaction detail is abnormal and has a different appearance than the plurality of alert message elements; and transmitting, by the server computer, the alert message to a mobile device.

Another embodiment of the invention relates to a server computer comprising a processor; a computer readable medium coupled to the processor, the computer readable medium comprising code, executable by the processor for implementing a method comprising: receiving transaction details for a transaction; analyzing transaction details to determine if a transaction detail is abnormal; determining that the transaction detail is abnormal; generating an alert message, wherein the alert message comprises a plurality of alert message elements, and a modified alert message element, wherein the modified alert message element is generated in response to determining that the transaction detail is abnormal and has a different appearance than the plurality of alert message elements; and transmitting the alert message to a mobile device.

Another embodiment of the invention relates to transmitting data for enrolling an account associated with a user to an alert notification system; and receiving, at a mobile device operated by the user, an alert message comprising a plurality of alert message elements and a modified alert message element, the modified alert message element having a different appearance than the plurality of alert message elements.

These and other embodiments of the invention are described in further detail below.

### BRIEF DESCRIPTION OF THE DRAWINGS

FIG. 1 illustrates an exemplary system with at least some of the elements for providing improved fraud prevention in accordance with embodiments of the invention.

FIG. 2 illustrates at least some of the elements of an exemplary server computer in accordance with embodiments of the invention.

FIG. 3 illustrates at least some of the elements of an exemplary mobile device in accordance with embodiments of the invention.

FIG. 4 illustrates an exemplary flow chart illustrating a method for enrolling in an alert notification system using embodiments of the invention.

FIG. 5 illustrates an exemplary flow chart illustrating a method implementing embodiments of the invention.

FIG. 6 illustrates an exemplary screen shot for a typical transaction alert message.

FIGS. 7A-7B and 8A-8D show exemplary screen shots of alert messages according to embodiments of the invention.

FIG. 9 shows an exemplary computer apparatus in accordance with some embodiments.

### DETAILED DESCRIPTION

Embodiments of the invention are directed to systems and methods for highlighting alert message elements for a user so that the user notices the alert messages. Embodiments of the invention provide for an additional level of fraud prevention by clearly identifying any abnormal detail relating to the transaction in the transaction alert message. An abnormal detail may include a variation relative to similar, prior transaction details. For example, if a transaction is conducted in an out of state location that is different from the billing address of the user associated with the payment account used for the transaction, the location of the transaction may be highlighted in an alert message to alert the user that the location of the transaction is suspicious.

Prior to discussing embodiments of the invention, description of some terms may be helpful in understanding embodiments of the invention.

As used herein, a “transaction” may include exchange of data and/or information between two entities. A transaction may be conducted using a payment device that may operate in a contact or contactless mode. Some non-limiting examples of payment devices may include mobile devices, PDAs, payment cards, smart cards, keychain devices, barcodes, etc. In some embodiments, a transaction may be conducted at an access device that may be suitable for communicating with a merchant computer or payment processing network. Some examples of access devices include POS (point-of-sale) devices, cellular phones, PDAs, personal computers (PCs), tablet PCs, hand-held specialized readers, set-top boxes, electronic cash registers (ECRs), automated teller machines (ATMs), virtual cash registers (VCRs), websites, and the like.

As used herein, a “transaction detail” may refer to any suitable detail associated with a financial transaction. For example, the transaction detail may include a user name, a transaction amount, the last four digits of an account identifier, a merchant name, a merchant location, a transaction date, a transaction time, a transaction category, a verification value (e.g., a CVV or card verification value, CVV2, DCVV, DCVV2, etc.), a transaction identifier, etc. In some embodiments, transaction details may be sent along with an authorization request message to a payment processing server. In some embodiments, the transaction details may be included in a transaction alert message sent to the user.

As used herein, an “alert message” may also be referred to as a notification and may include any type of electronic communication, or message, generated on the server computer and sent to a user and/or the specified message recipient. The alert message may be in the form of an email, SMS, or a text message.

In one embodiment, an alert message may be generated based upon user preferences that are stored on a server computer.

The alert message may include “alert message elements” which may include specific portions of text or graphics in an alert message. Alert message elements can include transaction details in some embodiments of the invention. Examples of alert message elements may include a user name, a transaction amount, the last four digits of an account identifier, a merchant name, a merchant location, a transaction date, a transaction time, a transaction category, a verification value (e.g., a CVV or card verification value, CVV2, DCVV, DCVV2, etc.), a transaction identifier, etc. Alert message elements may also include graphics or text that are not necessarily transaction details for a current transaction. Such alert elements may include logos of issuers or payment processing organizations, coupons, promotions, etc.

In embodiments of the invention, a plurality of alert message elements may generally be in a standard format for each of the plurality of alert messages. For example, one or more of a user name, a transaction amount, the last four digits of an account identifier, a merchant name, a merchant location, a transaction date, a transaction time, a transaction category, a verification value (e.g., a CVV or card verification value, CVV2, DCVV, DCVV2, etc.), a transaction identifier, logos of issuers, etc. may be in the same respective locations and may have the same general appearance on successive alert messages. As an illustration, in a series of successive alert messages based on successive transactions, the merchant name may be in the upper left corner of the alert messages and may be in 12 point courier font, while the transaction amounts for the transactions may be in the center of the alert messages and may be in 14 point Arial font.

A “modified alert message element” may be an alert message element that is modified from a standard format to alert the user of the particular importance of the transaction detail associated with the modified alert message element. The modified alert message element for a transaction detail may be modified in any suitable manner, relative to the standard format that would otherwise be used for that transaction detail. For example, a modified alert message element may be presented with highlighted text, a special font, with special characters (e.g., exclamation marks), change in location, blinking display, different color, additional graphics (e.g., a box or circle around text), etc. so as to draw user's attention to the modified alert message element. That is, the appearance of the modified alert message element may be different than a corresponding alert message element that has not been modified. In some embodiments, a modified alert message element or an abnormal detail may be presented in a subject line of an email message. In some embodiments of the invention, an alert message may include a risk score or a level, e.g., high, medium, low or a scale from 1-10, to indicate the risk associated with the transaction.

In embodiments of the invention, a “modified alert message element” may be modified if a server computer determines that one or more transaction details are abnormal. A transaction detail may be abnormal for a number of reasons. In some embodiments, a particular transaction detail may be inconsistent with prior similar transaction details from prior transactions conducted by the user, and/or may be indicative of a fraudulent transaction. For example, the average transaction amount for the last 100 transactions conducted by a user may be $50.00. The current transaction detail being analyzed may be a transaction amount for a transaction of $5000.00. This transaction detail would be considered abnormal, since the transaction amount is well beyond (e.g., more than 100% greater than the average spend of the user) what the user typically spends. In another embodiment, a transaction detail may be considered abnormal if it is inconsistent with a transaction detail for a transaction that was recently conducted. For example, an authentic user may have just purchased gas at a gas station in Los Angeles, Calif. The authentic user may then receive an alert message on his mobile phone that a purchase at a restaurant in New York City happened 5 minutes later. Because it is physically impossible to conduct different transactions in Los Angeles and New York City within 5 minutes, the alert message element associated with the transaction detail of “New York City” may be considered abnormal in this example and may be modified (e.g., highlighted) in an alert message according to an embodiment of the invention.

A “user” may be an entity, such as, an individual that may be associated with one or more payment accounts. The user may be able to enroll in a notification service and set up preferences for generating alert messages when a transaction is conducted using one of the payment accounts associated with the user. The user may also be capable of receiving an alert message on a mobile device when a transaction is conducted using one of the payment accounts associated with the user.

A “mobile device” may comprise any electronic device that may be transported and operated by a user, which may also provide remote communication capabilities to a network. The mobile device may be configured to receive alert messages from a server computer and display the alert message on a display screen in the mobile device. Examples of mobile devices include mobile phones (e.g. cellular phones), PDAs, tablet computers, net books, laptop computers, personal music players, hand-held specialized readers, etc.

A “user preference” may include any type of condition set up by the user for generating an alert associated with a particular account. In one embodiment, the condition may be pre-defined by the system and elected by the user to be applied to an account associated with the user when the user enrolls in a notification service. In some embodiments, the condition may be customized and defined entirely by the user and stored in association with that user's account in a database coupled to a server computer. User preferences may be modified, deleted or added as needed by the user who has a registered or enrolled account on the server computer. For example, the user preference may include generating an alert message as an email for a first account, and, generating an alert message as a text message for a second account, and whereas, no alert message generated for a third account. In some embodiments, the user preference may also include more than one recipient for receiving the alert message. In one embodiment, the user preference may include waiting for a pre-determined number of transactions before generating an alert message. In another embodiment, the user preference may include generating an alert message only if the transaction was not authorized.

A “server computer” is typically a powerful computer or cluster of computers. For example, the server computer can be a large mainframe, a minicomputer cluster, or a group of servers functioning as a unit. In one example, the server computer may be a database server coupled to a web server.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account and a secret token provided by a consumer. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, ATM identifier, ATM location, etc., as well as any other information that may be utilized in determining whether to identify and/or authorize a transaction.

An “authorization response message” may be an electronic message reply to an authorization request message generated by an account issuer, payment processing network, mobile payment processor, or a mobile network operator. The authorization response message may include, by way of example only, one or more of the following status indicators: Approval—transaction was approved; Decline—transaction was not approved; or Call Center—response pending more information, may call the toll-free authorization phone number. The authorization response message may also include an authorization code, which may be a code that an issuing bank or other entity (e.g. a mobile network operator or mobile payment processor) returns in response to an authorization request message in an electronic message (either directly or through the payment processing network) to the transaction apparatus (e.g. an ATM) that indicates approval of the transaction and completes the transaction. The code may serve as proof of authorization.

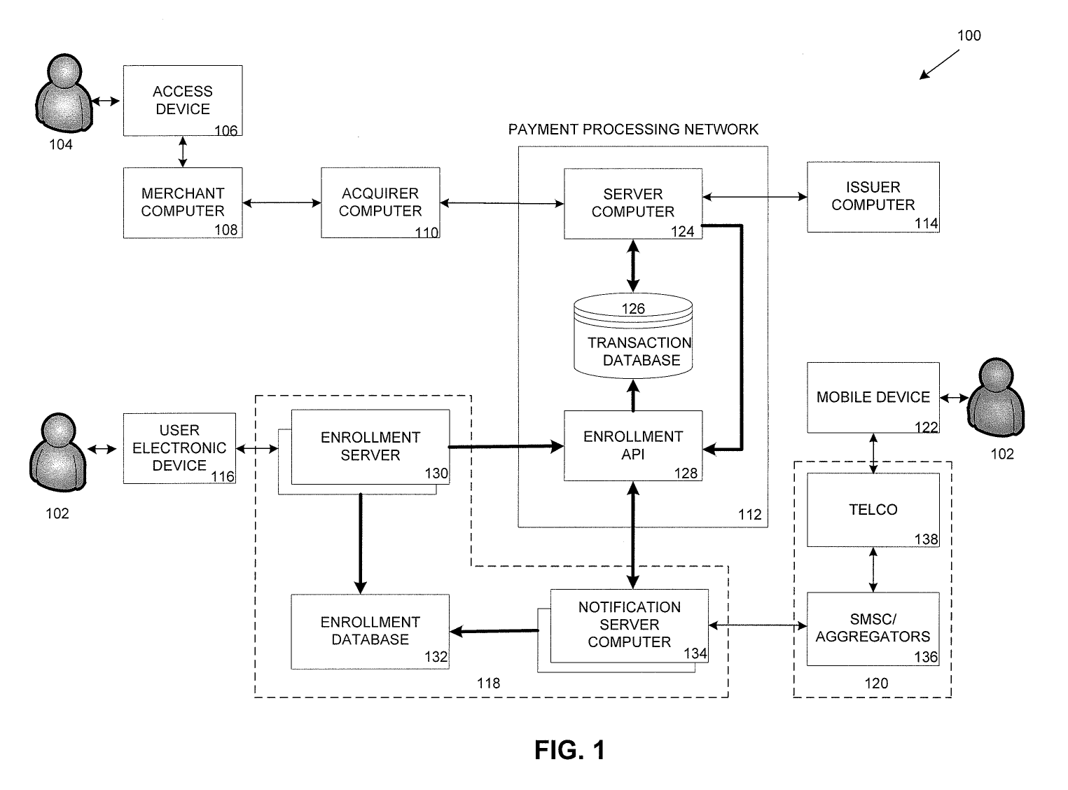

FIG. 1 illustrates an exemplary system 100 with at least some of the elements for providing improved fraud prevention using embodiments of the invention. The system 100 comprises a payment processing network 112, which may reside (in an operational sense) between an acquirer computer 110 and an issuer computer 114. The payment processing network 112 may comprise a central server computer 124, as well as a transaction database 126, and an enrollment API 128. The acquirer computer 110 may be associated with an acquirer and the issuer computer 114 may be associated with an issuer. A merchant computer 108 may be in communication with the acquirer computer 110, and an access device 106 such as a POS terminal may be in communication with the merchant computer 108. A person 104 may conduct a transaction using the access device 106. This particular subsystem may be used to conduct payment transactions using credit and debit devices such as credit and debit cards.

FIG. 1 also shows an alert notification system 118 operatively coupled to the payment processing network 112, and a service provider 120 may be in communication with the alert notification system 118. The alert notification system 118 may include an enrollment server computer 130, which communicates with an enrollment database 132 and a notification server computer 134. A user may 102 may also use an electronic device 116 to communicate with the enrollment server 130.

The use of the system 100 and its components can now be described.

In embodiments of the invention, the user 102 may enroll in an alert notification system in order to receive alert messages when transactions are performed on an account associated with the user. The user 102 may enroll with the alert notification system 118 using the user electronic device 116. The user electronic device 116 may be a personal computer, a mobile device (e.g., mobile phone, tablet, PDA, notepad, laptop, etc.) or any such suitable device configured to access an enrollment server 130 for enrolling one or more accounts associated with the user 102 in an alert notification system 118.

As part of the enrollment process, the user 102 may provide user information, such as, name, personal account numbers (PAN), billing address, phone number, email, shipping address and any such relevant information into a web application that may be associated with the enrollment server 130. The user information may be stored in an enrollment database 132 that may be coupled to the enrollment server 130. In one embodiment, the enrollment database 132 is external, e.g., in a cloud storage environment.

The user 102 may set up user preferences when enrolling an account in the alert notification system 118 in order to receive an alert message when a transaction is conducted on an account associated with the user. In some embodiments, the alert notification system 118 may already have user information stored in the enrollment database 132, but the user may need to set up user preferences for receiving alert messages. For example, a user preference may include receiving a text message on a particular mobile number when a transaction is conducted using a particular account. In another example, user preference may include sending an alert message on a second mobile device that may be associated with a different user (e.g., spouse). In some embodiments, user preferences may be different for different accounts associated with the same user.

The alert notification system 118 may also include a notification server computer 134 that may be configured to communicate with the payment processing network 112 and the service provider 120. The alert notification system 118 may be associated with an issuer computer 114, the payment processing network 112 or a third party system. The alert notification system 118 may also communicate through the enrollment application processor interface (API) 128 associated with the payment processing network 112. The enrollment API 128 may be configured to provide a communication interface between the alert notification system 118 and the payment processing network 112. The server computer 124 can determine if a transaction conducted on an account stored in a transaction database 126 is associated with a user that is registered in the alert notification system 118. The enrollment API 128 may be configured to update the transaction database 126 with user preferences for each account associated with the user 102 such that the server computer 124 may generate an alert message based on the user preferences when a transaction is conducted on an account associated with the user 102. The transaction database 126 may also be configured to store a transaction history for each account associated with the user 102. The transaction database 126 may be internally or externally (e.g., cloud storage) coupled to the server computer 124.

The user 104 may use a payment card (e.g., credit, debit, prepaid, etc.) to conduct a transaction or conduct a card-not-present transaction using an account associated with the user 102 at an access device 106. The access device 106 may use any suitable contact or contactless mode of operation to send or receive data from, or associated with, a portable consumer device (i.e., payment card, mobile device, etc.). The access device 106 may be a POS terminal, a card reader, a personal computer, a mobile device or any such device capable of conducting a transaction. In some embodiments the user 102 and the user 104 may be the same entities. In some embodiments, the user 104 may be an unauthorized user and may be conducting a fraudulent transaction using an account associated with the user 102. In some embodiments, the user 104 may be authorized to conduct a transaction on accounts associated with the user 102, e.g., the user 104 may be related or known to the user 102.

As a result of conducting a transaction at the access device 106, the merchant computer 108 may receive payment information (PAN, verification values, expiration date, etc.) from the access device 106. The merchant computer 108 may generate an authorization request message that may include information received from the access device 106 along with additional transaction details such as a transaction amount, a merchant name and identifier, a location of the transaction, a date and time of the transaction, a category of transaction, etc. Other transaction details may include product identifiers (e.g., SKUs or stock keeping units). In some embodiments, the authorization request message may include transaction details such as whether the payment account is a business, corporate or a personal account. In other embodiments, the authorization request message may include details regarding whether the transaction was conducted using a manual card entry with or without a verification code (i.e., in-store card-not-present transaction).

After it receives the authorization request message, the merchant computer 108 may electronically transmit the authorization request message to the acquirer computer 110. The acquirer computer 110 is typically a system for an entity (e.g., a bank) that has a business relationship with a particular merchant or other entity. The acquirer computer 110 may forward the authorization request message to the payment processing network 112 (e.g., server computer 124).

The payment processing network 112 may include data processing subsystems, networks, and operations used to support and deliver authorization services, and clearing and settlement services. An example of payment processing network 112 includes VisaNet®, operated by Visa®. The payment processing network 112 may include wired or wireless network, including the internet. The issuer computer 114 is typically a computer run by a business entity (e.g., a bank) that may have issued the payment (credit/debit) card, account numbers or payment tokens used for the purchase. Some systems can perform both issuer computer 114 and acquirer computer 110 functions.

The server computer 124 may be configured to receive the transaction details for the transaction performed on an account associated with the user 102. The server computer 124 may determine if the transaction on the account qualifies for alert messaging based on the user preferences associated with the account information stored in the transaction database 126. In some embodiments, the transaction database 126 may also include historical transaction data for one or more accounts associated with the user 102 that may be analyzed to determine a variation from the norm for transactions conducted on the one or more accounts. For example, if the historical transaction data indicates that a particular account is mostly used for transactions for less than $100, then a transaction amount of over $1000 may indicate that the transaction amount is abnormal as it varies from the majority of past transaction amounts for past transactions. In another embodiment, if a user has never purchased children's clothing, then a transaction conducted at a children's clothing store may also indicate that the particular transaction is abnormal for the authorized account user of the transaction account.

As a result of analysis, if the server computer 124 determines an abnormal variation based on the one or more transaction details (e.g., transaction amount, location, category, etc.), the server computer 124 may generate an alert message. Using embodiments of the invention, the server computer 124 may modify specific alert message elements in the alert message that are related to any abnormal transaction details. In some embodiments of the invention, an alert message may include a risk score or a level, e.g., high, medium, low or a scale from 1-10, to indicate the risk associated with the transaction. The modification may be highlighting the text or graphic of the alert message element relative to other alert message elements, using a special font color, size, or type for the modified alert message element, and/or applying a special graphic to the alert message element (e.g., bolded or underlined letters), etc. In other embodiments, it is possible to place the modified alert element in a different location in the alert message so that it is noticed by the user and does not look like every other alert message. For example, the modified alert message element may be placed in the middle of the alert message, rather than to the side of the alert message to call specific attention to the user 102. In some embodiments, the abnormal detail or the modified alert message elements relating to the abnormal detail may be specified in the subject line of the email message to draw user's attention. In some embodiments, the subject line of the email message for the transaction alert may be in a question format with the abnormal detail (e.g., Transaction Alert HIGH: Did you conduct a transaction in Flint, Mich.?).

In some embodiments, the customized alert message may be communicated to the notification server computer 134 by the server computer 124 in order to distribute the alert message to the user 102. The alert message may be in the form of an SMS message, a text message or an email. The notification server computer 134 may be further configured to communicate with the service provider 120, which may comprise a telecommunications network (telco) 138 and short message service center (SMSC) or aggregators 136. The SMSC/aggregators 136 may act as a gateway to provide a short message service to a mobile phone network through the telecommunication network 138. The telecommunication network 138 may include wireless carriers, mobile network operators, internet service providers or any such service provider for telephony and data communications.

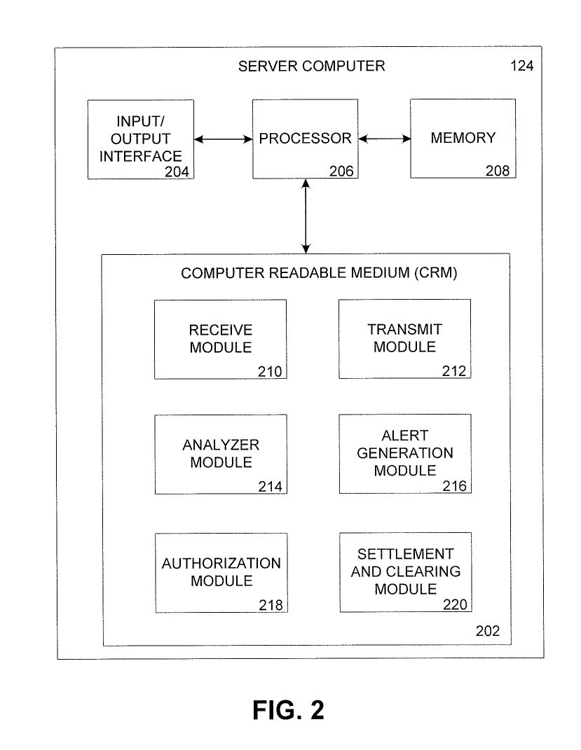

FIG. 2 illustrates at least some of the elements of an exemplary server computer 124 in accordance with embodiments of the invention. In some embodiments, the server computer may comprise a processor and a computer readable medium coupled to the processor. The computer readable medium comprises code, executable by the processor for implementing a method comprising: receiving transaction details for a transaction, analyzing the transaction details to determine if a transaction detail is abnormal; determining that the transaction detail is abnormal; generating an alert message, wherein the alert message comprises a plurality of alert message elements, and a modified alert message element, wherein the modified alert message element is generated in response to determining that the transaction detail is abnormal and has a different appearance than the plurality of alert message elements; and transmitting the alert message to a mobile device.

The server computer 124 may be configured to receive transaction details for a transaction performed on an account associated with the user 102 and generate an alert message based on variations in the one or more transaction details. The server computer 124 may comprise an input-output (IO) interface 204, which may be configured to interface with other entities, such as, the acquirer computer 110, issuer computer 112, transaction database 126, etc. for exchanging data and information (e.g., transaction and authorization related data). The server computer 124 may also comprise a processor 206 that may be configured to execute instructions or code in order to implement methods, processes or operations, as well as a memory 208. The memory 208 may comprise any combination of volatile and/or non-volatile memory such as, for example, buffer memory, RAM, DRAM, ROM, flash, or any other suitable memory device.

The computer readable medium (CRM) 202 may comprise code, executable by the processor 206 for implementing methods using embodiments of the invention. The computer readable medium 202 may comprise a receive module 210, a transmit module 212, an analyzer module 214, an alert generation module 216, an authorization module 218 and a settlement and clearing module 220.

The receive module 210 may be configured to receive transaction details for a transaction. In one embodiment, the transaction is conducted by the user 104 on an account associated with the user 102. The transaction details may be received as part of an authorization request message from the merchant computer 108 via the acquirer computer 110, and the authorization request message may be forwarded to the issuer computer 114 for authorization.

The alert generation module 216 may be configured to determine if the transaction qualifies for alert messaging based on user preferences associated with the account. The user preferences may be set up by the user 102 during enrollment in the alert notification system 118 or any other time before the current transaction. For example, the user preference may include the accounts for which an alert message may be generated. In some embodiments, the user preference may include a preference for the type of alert message that is to be sent (e.g., e-mail or SMS).

The analyzer module 214 may be configured to analyze transaction details for abnormal variations. For example, the analyzer module 214 may analyze the historical transaction data associated with the account to determine common patterns and compare it with the transaction details for variations. For example, if the user's last transaction was made near his billing address then an out-of-state transaction may indicate an abnormal variation in the location. In another example, if the user does not have a history of spending over $100 on an account, then a transaction amount for a transaction over $1000 may be abnormal. In some embodiments, the analyzer module 214 may also monitor transactions for other transaction details that may appear to suggest that a fraudulent or abnormal transaction is occurring (e.g., a corporate or a business account is used for a transaction at a salon).

The alert generation module 216 may be configured to generate an alert message based on the variations or abnormalities in the transaction details. Using embodiments of the invention, specific alert message elements may be modified based on the variation. An email alert message may include modified alert message elements in the subject line and the body of the message and a text/SMS alert message may include modified alert message elements in the body of the message.

A transmit module 212 may be configured to transmit the modified alert message for distribution to the mobile device 122 associated with the user 102. For example, the server computer 112 may notify the notification server computer 134 through the enrollment API 128 that an alert message is generated for a transaction on an account associated with the user 102. The notification server computer 134 may communicate with the service provider 120 to send the alert message to the mobile device 122 associated with the user 102.

An authorization module 218 may be configured to process the authorization request message received from the acquirer computer 110 and determine the appropriate destination for the authorization request message. The settlement and clearing module 220 may be configured to perform settlement and clearing of the transactions.

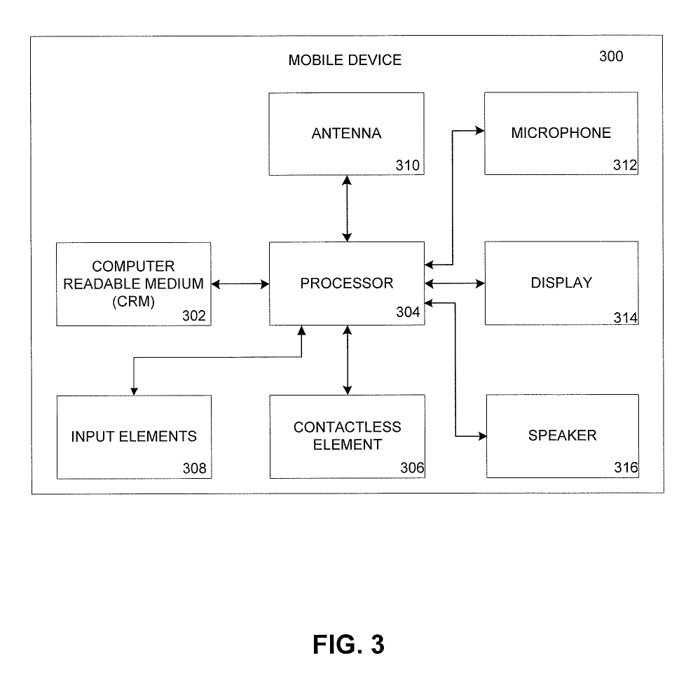

FIG. 3 illustrates at least some of the elements of an exemplary mobile device 300 in accordance with embodiments of the invention. The mobile device 300 may comprise a computer readable medium 302, an antenna 310, a microphone 312, a display 314, a speaker 316, a contactless element 306, and input elements 306, and these may all be operatively coupled to a processor 304.

The mobile device 300 may be a notification device to receive alert messages (i.e., mobile device 122), a payment device that may be used to make payments, an access device that may receive information from a user to conduct a transaction (i.e., access device 106), a communication device to allow a user to log on to a website to enroll in an alert notification service (i.e., user electronic device 116), etc. The exemplary mobile device 300 may comprise a computer readable medium (CRM) 302 comprising code executable by the processor 304 for implementing methods using embodiments of the invention. The computer readable medium 302 may be in the form of a memory that stores data and could be internal to the device or hosted remotely (i.e., cloud) and accessed wirelessly by the device. A contactless element 306 may be capable of transmitting and receiving wireless data or instructions using a short range wireless communications capability.

The mobile device 300 may be a mobile phone, a tablet, a PDA, a laptop or any such electronic device capable of communicating and transferring data or control instructions via a wireless network (e.g., cellular network, internet, etc.) and short range communications. The mobile device 300 may include the processor 304 (e.g., a microprocessor) for processing the functions of a mobile device (e.g., a phone) and a display 314 to allow a user to see messages (e.g., alert messages), phone numbers, images, and other information. The mobile device 300 may further include input elements 308 to allow the user to input information into the device (e.g., using a keypad, touch screen, mouse, etc.), a speaker 316 to allow the user hear voice communication, music, etc., and a microphone 312 to allow the user transmit her voice through the device. The mobile device 300 may also include an antenna 302 for wireless data transfer.

In some embodiments, the mobile device 300 may allow the user 102 to logon to the enrollment server 130 using a communications network so that the user 102 may enroll one or more financial accounts in to the alert notification system 118 using a web application. The mobile device 300 may further allow the user 102 set up preferences for generating alert messages.

In some embodiments, the mobile device 300 may be configured to receive alert messages via the antenna 310 when a transaction is conducted on an account associated with the user 102 that may be displayed on the display 314. The alert message may be received as an email, a text message, a tweet, an SMS or any such suitable communication medium. In some embodiments, an alert message in the form of an email may include the abnormal detail or the modified alert message element related to the abnormal detail in the subject line of the email message to draw user's attention.

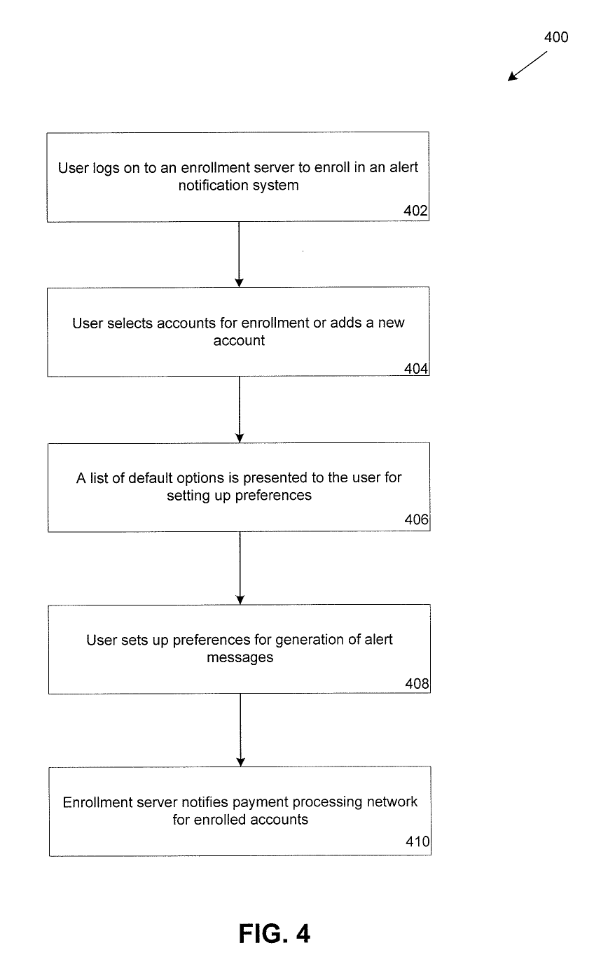

FIG. 4 illustrates an exemplary flow chart 400 illustrating a method for enrolling in an alert notification system using embodiments of the invention.

In step 402, a user may log on to an enrollment server to enroll in an alert notification system. For example, the user 102 may log on to the enrollment server 130 using the user electronic device 116 and enroll in the alert notification system 118 using a web application that may be linked to the enrollment API 128. The user 102 may enroll in the alert notification system 118 in order to receive alert messages for transactions conducted using one or more accounts associated with the user 102. In some embodiments, the user 102 may need a password and/or a login ID to access the enrollment server 130.

In step 404, the user 102 may select one or more existing accounts for enrollment in to the alert notification system or add a new account. In some embodiments, the accounts may be issued by an issuer or financial institution associated with the issuer computer 114.

In step 406, a list of default options may be presented to the user 102 for selection. In some embodiments, the user 102 may make selections or add new preferences using a web application. For example, there may be an option to select which accounts should have alert messages generated for transactions. In another example, there may be an option to generate alert messages for specific types of transactions (e.g., only for purchases, and not for cash withdrawals). In yet another example, the user may select the types of alert messages that are to be received.

In step 408, the user may set up preferences for the generation of alert messages. For example, the user 102 may enter contact information, such as, e-mail address, mobile phone number, etc., to which the alert messages are to be sent. The preferences may be stored in the enrollment database 132.

In step 410, the enrollment server 130 may notify the payment processing network 132 about which accounts are enrolled for alert messaging. In some embodiments, the transaction database 126 may be updated by the enrollment API 128 in order to reflect the user preferences set up in the enrollment database 132 for accounts associated with the user 102.

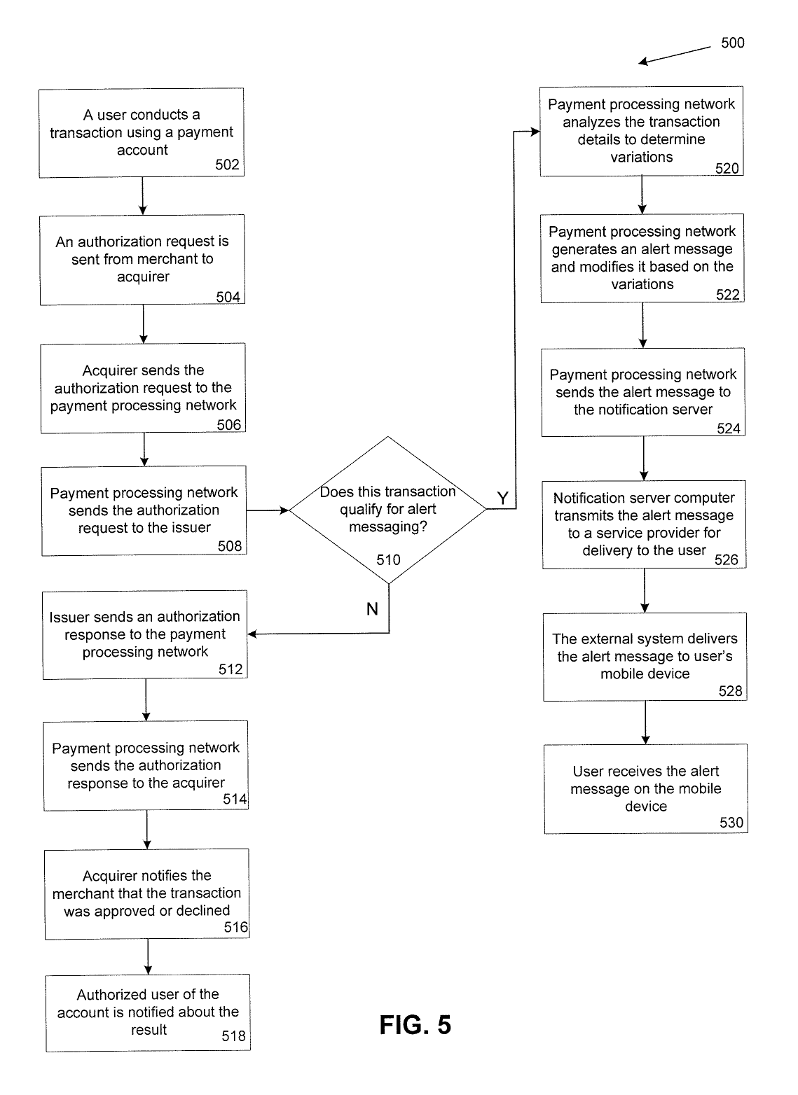

FIG. 5 illustrates an exemplary flow chart 500 illustrating a method implementing embodiments of the invention.

In step 502, a user conducts a transaction using a payment account. For example, the user 104 may make a purchase transaction using the access device 106. In some embodiments, the user 104 may have a portable consumer device and may pass the portable consumer device by the access device 106. The portable consumer device may be a payment card (credit card, debit card, prepaid card, etc.) or a mobile device (mobile phone, tablet, PDA, RFID tag, etc.). The access device 106 thereafter generates an authorization request message. The authorization request message may include transaction details such as a transaction amount, an account number, a merchant name and/or merchant location, a date and time of transaction, a user name and any such relevant information needed for processing the authorization request message.

In step 504, the authorization request message is received by and is transmitted from the merchant computer 108 to the acquirer computer 110.

In step 506, the acquirer computer 110 transmits the authorization request message to the payment processing network 112.

In step 508, the server computer 124 in the payment processing network 112 sends the authorization request message to the issuer computer 114 to authorize the transaction. In other embodiments, the server computer 124 in the payment processing network 112 may reject the transaction and notify the issuer and/or the merchant if it determines that the transaction is potentially fraudulent.

In step 510, the alert generation module 216 determines if the transaction qualifies for alert messaging by analyzing the user preferences associated with the account on which the transaction was conducted. If it does not, then the processing proceeds to steps 512, 514, 516, and 518. If it does, then the processing proceeds to steps 520, 522, 524, 526, 528, and 530.

In step 512, the issuer computer 114 transmits an authorization response message to the payment processing network 112. The authorization response message may include the information whether the transaction was approved or declined. The authorization response message may also include an authorization code, which may provide proof of authorization.

In step 514, the payment processing network 112 transmits the authorization response message to the acquirer computer 110.

In step 516, the acquirer computer 110 transmits the authorization response message to the merchant computer 108 and then to the access device 108 to inform the merchant and the user 104 as to whether or not the transaction was approved.

In step 518, the user 102 and/or user 104 is notified as to whether the transaction was approved or declined.

Referring back to step 510, if an alert message is to be generated, then in step 520, the server computer 124 in the payment processing network 112 analyzes the transaction details to determine variations in them. For example, the analyzer module 214 may compare historical transaction data associated with the account stored in the transaction database 126 to determine a variation in one or more transaction details relative to similar past transaction details. As an illustration, if the user 102 has a history of spending of less than $50 at drug stores, then a transaction amount over $200 at the drug store may be an abnormal transaction amount. In one embodiment, the analyzer module 214 may determine if the transaction involved manual data entry at the access device 106 (e.g., POS terminal) on an account instead of a swipe or a wave.

In step 522, the server computer 124 in the payment processing network 112 generates an alert message if an abnormal variation is found in any transaction details. The alert generation module 216 may generate an alert message based on the analysis of the analyzer module 214 by clearly identifying any abnormalities in the transaction details. The server computer 124 can generate an alert message with a plurality of alert message elements in a standard format, and any modified alert message elements in a non-standard format to highlight the alert message elements to the mobile device 122 of the user 102. In some embodiments of the invention, an alert message may include a risk score or a level, e.g., high, medium, low or a scale from 1-10, to indicate the risk associated with the transaction. This may allow the user to pay extra attention to a small subset of alerts that may be especially risky. In some embodiments, the risk score or level may be in a non-standard format based on the severity of the risk (e.g., HIGH or 10 may be in bold letters or red color).

In step 524, the server computer 124 in the payment processing network 112 transmits the alert message with the modified alert message elements and the standard alert message elements to the notification server computer 134 for distribution to the user 102 associated with the account.

In step 526, the notification server computer 134 transmits the alert message to the service provider 120 for delivery to the mobile device 122 associated with the user 102. The notification server computer 134 may also provide the contact information (e.g., email address or mobile phone number) associated with the user 102 stored in the enrollment database 132 to the service provider 120 for delivering the alert message.

In step 528, the service provider 120 delivers the alert message to the mobile device 122 associated with the user 102 via a communication network (e.g., mobile phone network).

In step 530, the user 102 receives the alert message on the mobile device 122. Using embodiments of the invention, the alert message may clearly identify any abnormal transaction details regarding the transaction to draw the user's attention to them. In one embodiment, the user 102 may see the alert message on the display 314 of the mobile device. If the transaction is potentially fraudulent, the user 102 may choose to contact the issuer of the account to reject the transaction or block future transactions on the account.

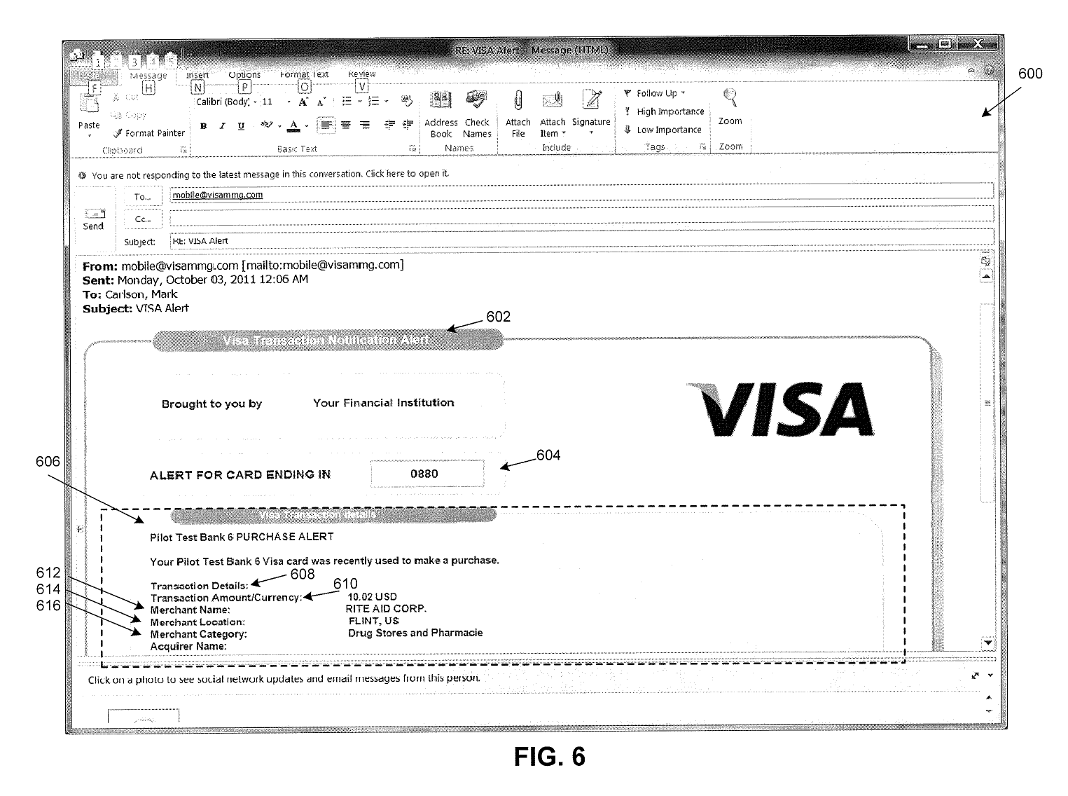

FIG. 6 illustrates an exemplary screen shot for a typical transaction alert message.

A screen shot 600 illustrates a transaction notification alert 602 in an email message. The alert includes last four digits of the account (e.g., 0880) used for the transaction as indicated by a window 604. A transaction detail window 606 includes a purchase alert message indicating that the associated account was recently used to make a purchase. Transaction details 608 include a transaction amount 610, a merchant name 612, a merchant location 614 and a merchant category 616. Although the information in them may differ from transaction to transaction, all of these transaction details may appear with the same general font size and shape, and location for successive transaction alert messages.

Note that the transaction details included in the typical alert message do not stand out to call user's attention to an abnormal detail included in the alert message. For example, the user may be residing in California when the transaction was conducted in Flint, Mich. on the user's account. A careful inspection would have shown that the transaction was conducted in Flint, Mich. However, typical alert messages may all look the same and nothing may stand out to the user after a quick review of the alert message. Further, there is no indication in the alert message regarding whether the transaction was conducted using manual data entry at the POS terminal or other access device.

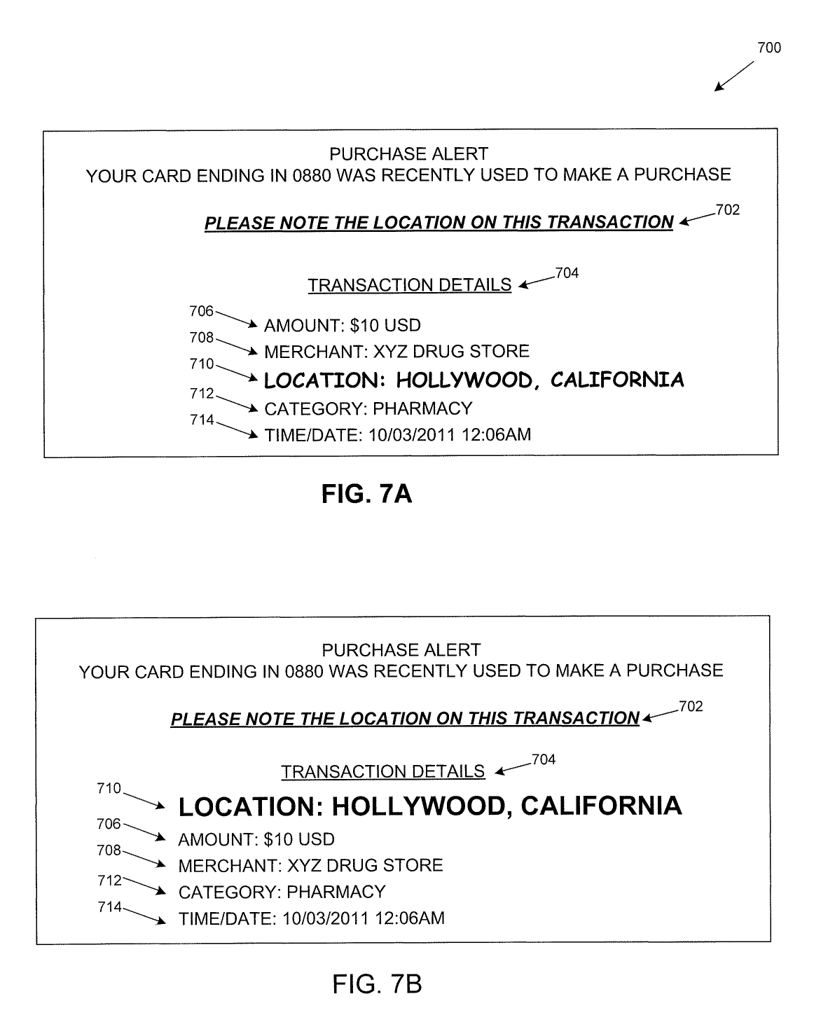

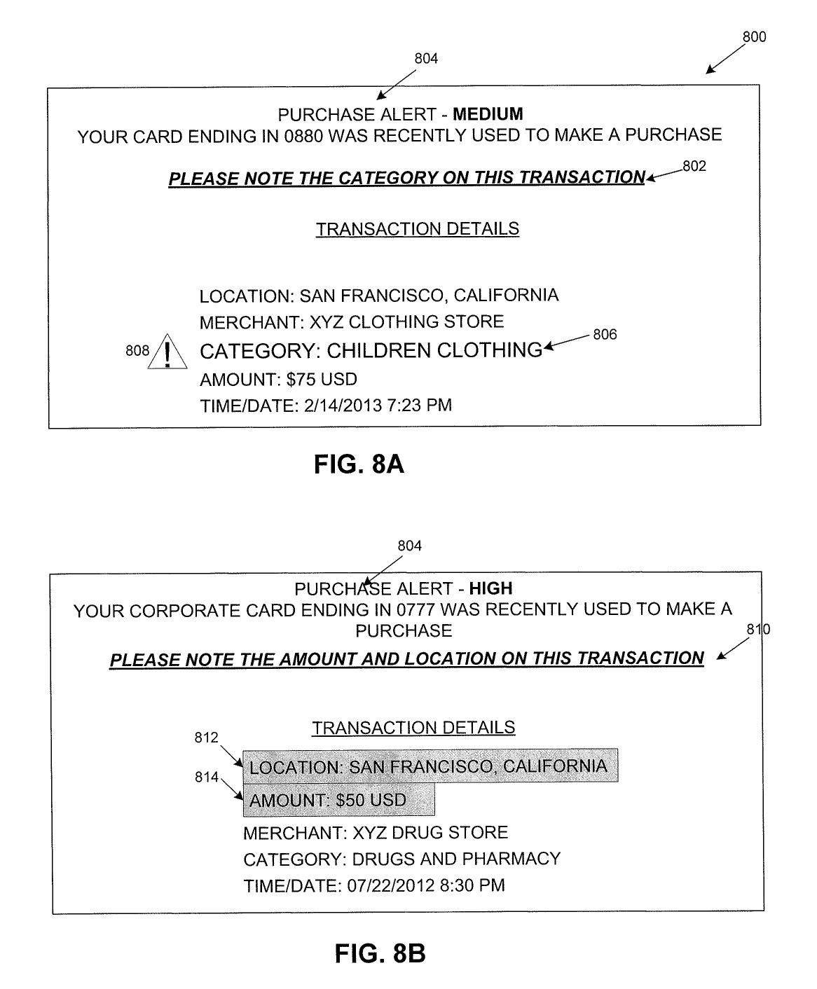

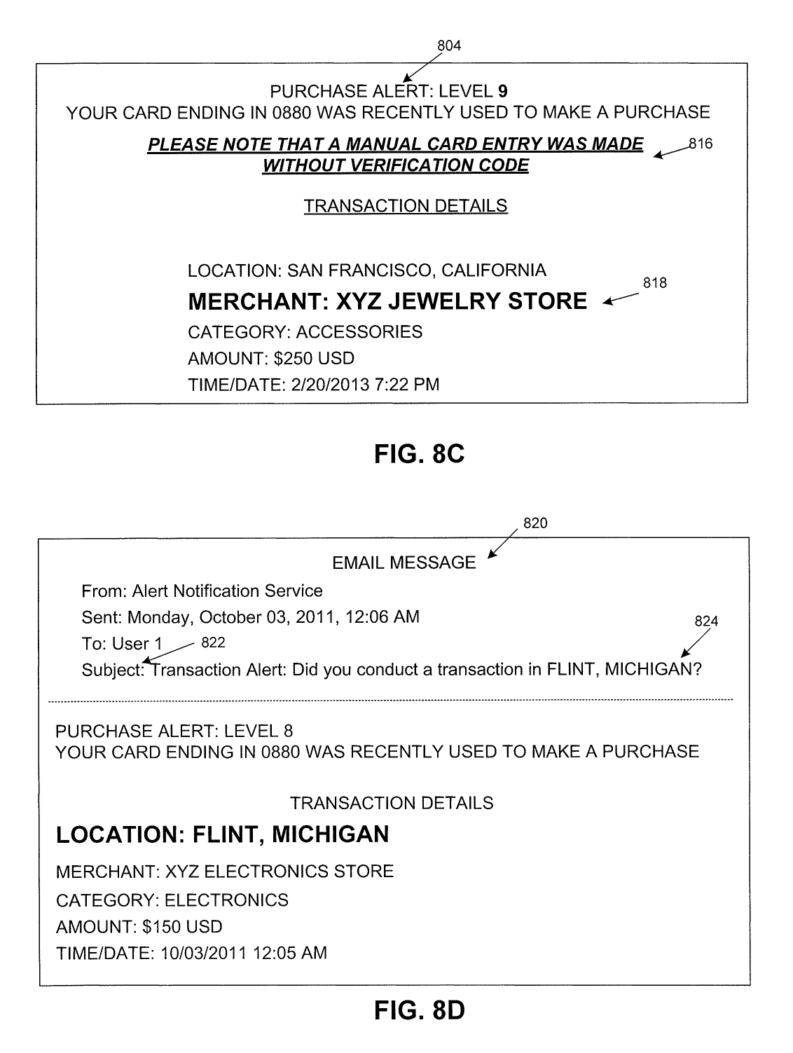

Embodiments of the invention that may be used to draw user's attention to the specific alert message elements in the alert message may be discussed with reference to exemplary screen shots in FIGS. 7A-7B and 8A-8D.

FIGS. 7A-7B illustrate exemplary screen shots showing modified alert message elements. The modified alert message elements stand part (visually) from other alert message elements that are standard and not modified (in terms of size, shape, color, or style).

As illustrated in FIG. 7A, the alert message includes a risk element 702 at the top (e.g., PLEASE NOTE THE LOCATION ON THIS TRANSACTION) of the alert message 700. Transaction details 704 include an amount 706, a merchant 708, a merchant location 710, a merchant category 712 and a time/date of the transaction 714. In this embodiment, the merchant location 710 (Hollywood, Calif.) is in bold with a different font as compared to the other alert message elements 706, 708, 712, and 714 to draw user's attention to the merchant location 710.

Another exemplary alert message according to an embodiment of the invention is illustrated in FIG. 7B. The alert message includes the risk element 702 at the top (e.g., PLEASE NOTE THE LOCATION ON THIS TRANSACTION) of the alert message. In this embodiment, the modified alert message element of the merchant location 710 is in bold and is in larger font. The position of the modified alert message element is reordered to a non-standard position so that it is at the top of the list of transaction details.

FIGS. 8A-8D illustrate exemplary screen shots of alert messages showing other types of modified alert message elements.

In FIG. 8A, the alert message 800 includes a risk element 802 at the top (e.g., PLEASE NOTE THE CATEGORY ON THIS TRANSACTION). A purchase alert level 804 indicates medium risk level for this particular transaction. The transaction details in the alert message 800 include a merchant category 806 displayed in bigger font. In this embodiment, an image 808 is placed next to the merchant category 806 to draw user's attention to it. The other alert message elements (e.g., merchant location, merchant name, transaction amount, and transaction time and date), are standard alert message elements and have standard formatting which would be used for all alert messages that do not have modified alert message elements.

In FIG. 8B, the alert message includes a risk element 810 at the top (e.g., PLEASE NOTE THE AMOUNT AND LOCATION ON THIS TRANSACTION) of the alert message. The purchase alert level 804 indicates high risk level for this particular transaction. In this embodiment, a location 812 and an amount 814 are highlighted and reordered to be before other transaction details to draw user's attention to them. Other alert message elements including the merchant name, the merchant category, and the transaction time and date are standard alert message elements.

As illustrated in FIG. 8C, the alert message includes the risk element 816 at the top (e.g., PLEASE NOTE THAT A MANUAL CARD ENTRY WAS MADE WITHOUT VERIFICATION CODE). The purchase alert level 804 indicates a level 9 for this particular transaction. In this embodiment, a merchant name 818 is displayed in bold and larger font to draw user's attention to the merchant name. Other alert message elements including the merchant location, the merchant category, the transaction amount, and the transaction time and date are standard alert message elements.

As illustrated in FIG. 8D, an alert message may be in the form of an email message 820. An abnormal detail 824 may be included in a subject line 822 of the email message 820 in a question format to draw user's attention. In this example, FLINT, MICHIGAN is the abnormal detail (location) included in the subject line. In some embodiments, a modified alert message element relating to an abnormal detail may be included in the subject line of the email message. In this embodiment, the location is displayed in bold and larger font in the body of the email message to draw user's attention. Other alert message elements including the merchant name, the merchant category, the transaction amount, and the transaction time and date are standard alert message elements.

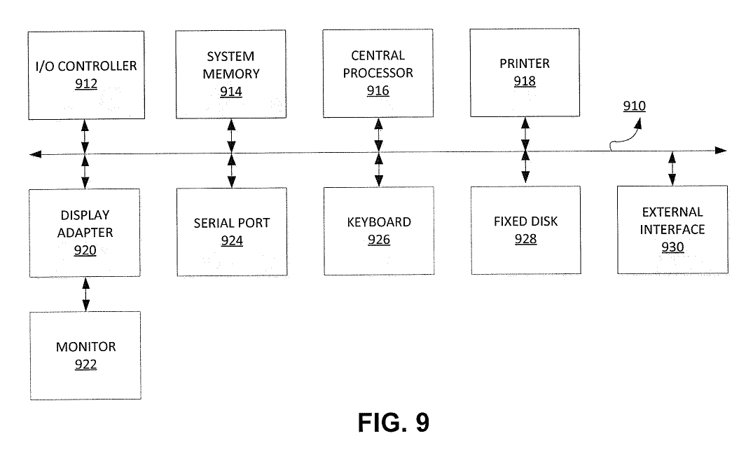

FIG. 9 is a high level block diagram of a computer system that may be used to implement any of the entities or components described above. The subsystems shown in FIG. 9 are interconnected via a system bus 910. Additional subsystems include a printer 918, keyboard 926, fixed disk 928, and monitor 922, which is coupled to display adapter 920. Peripherals and input/output (I/O) devices, which couple to I/O controller 912, can be connected to the computer system by any number of means known in the art, such as a serial port. For example, serial port 924 or external interface 930 can be used to connect the computer apparatus to a wide area network such as the Internet, a mouse input device, or a scanner. The interconnection via system bus 910 allows the central processor 916 to communicate with each subsystem and to control the execution of instructions from system memory 914 or the fixed disk 928, as well as the exchange of information between subsystems. The system memory 914 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A method comprising:
receiving transaction details for a transaction;
analyzing, by a server computer, the transaction details to determine if a transaction detail is abnormal;
determining, by the server computer, that the transaction detail is abnormal;
generating, by the server computer, an alert message, wherein the alert message comprises a plurality of alert message elements, and a modified alert message element, wherein the modified alert message element is generated in response to determining that the transaction detail is abnormal and has a different appearance than the plurality of alert message elements; and
transmitting, by the server computer, the alert message to a mobile device.

2. The method of claim 1, wherein the transaction detail is a transaction amount, a transaction location, a transaction date, or a transaction time.

3. The method of claim 1, wherein receiving the transaction details comprises receiving the transaction details by the server computer in an authorization request message, which is generated by an access device at a merchant after the access device interacts with a portable consumer device.

4. The method of claim 1, wherein the modified alert message element comprises bolded or highlighted text, relative to the plurality of alert message elements, which are in a standard format.

5. The method of claim 1, wherein analyzing, by the server computer, the transaction details to determine if a transaction detail is abnormal comprises determining that the transaction detail is inconsistent with prior similar transaction details from prior transactions conducted by a user.

6. A server computer comprising:
a processor;
a computer readable medium coupled to the processor, the computer readable medium comprising code, executable by the processor for implementing a method comprising:
receiving transaction details for a transaction;
analyzing, by a server computer, the transaction details to determine if a transaction detail is abnormal;
determining, by the server computer, that the transaction detail is abnormal;
generating, by the server computer, an alert message, wherein the alert message comprises a plurality of alert message elements, and a modified alert message element, wherein the modified alert message element is generated in response to determining that the transaction detail is abnormal and has a different appearance than the plurality of alert message elements; and
transmitting, by the server computer, the alert message to a mobile device.

7. The server computer of claim 6, wherein receiving the transaction details comprises receiving the transaction details by the server computer in an authorization request message.

8. The server computer of claim 6, wherein the alert message is a text message.

9. The server computer of claim 6, wherein the computer readable medium further comprises code, executable by the processor, for performing authorization and clearing and settlement processes.

10. The server computer of claim 6, wherein determining that the transaction detail is abnormal comprises determining that the transaction detail is inconsistent with a similar transaction detail in a prior transaction.

11. A method comprising:
transmitting data for enrolling an account associated with a user to an alert notification system; and
receiving, at a mobile device operated by the user, an alert message comprising a plurality of alert message elements and a modified alert message element, the modified alert message element having a different appearance than the plurality of alert message elements.

12. The method of claim 11, wherein the data includes user preferences for each of the one or more accounts.

13. The method of claim 11, wherein the alert message is an SMS message.

14. The method of claim 11, wherein the modified alert message element has a different font or color than the plurality of alert message elements.

15. The method of claim 11, wherein the alert message is in the form of an email.
